(19) United States
(12) Patent Application Publication
(10) Pub. No.: US 2014/0295723 A1
(43) Pub. Date: Oct. 2, 2014

(54) NANOSILICA CONTAINING BISMALEIMIDE COMPOSITIONS

(71) Applicant: 3M INNOVATIVE PROPERTIES COMPANY, St. Paul, MN (US)

(72) Inventors: James M. Nelson, Woodbury, MN (US); Wendy L. Thompson, Roseville, MN (US); William J. Schultz, North Oaks, MN (US)

(21) Appl. No.: 14/353,629

(22) PCT Filed: Oct. 24, 2012
(86) PCT No.: PCT/US12/61609

§ 371 Date: Apr. 23, 2014

Related U.S. Application Data
(60) Provisional application No. 61/550,671, filed on Oct. 24, 2011.

(51) Int. Cl. C08K 9/04; B29C 70/52; B29C 70/48; C08L 79/08; C08K 7/06

(52) U.S. Cl. CPC C08K 9/04; C08L 79/08; C08K 7/06; B29C 70/48; B29C 70/52
USPC 442/59; 523/216; 264/257; 264/136; 242/470

(57) ABSTRACT

There are provided curable resin sols comprising an essentially volatile-free, colloidal dispersion of substantially spherical nanosilica particles in a curable bisimide resin, said particles having surface-bonded organic groups which render said particles compatible with said curable bisimide resin. There are also provided compositions comprising such curable resin sol and reinforcing fibers, a process for preparing such compositions, and various articles made using such curable resin sols and compositions.

### FIELD

This disclosure relates to compositions comprising curable resin, to fiber-reinforced composites derived therefrom, and to methods of improving the mechanical properties of fiber-reinforced composites.

### BACKGROUND

Advanced structural composites are high modulus, high strength materials useful in many applications requiring high strength to weight ratios, e.g., applications in the automotive, sporting goods, and aerospace industries. Such composites typically comprise reinforcing fibers (e.g., carbon or glass) embedded in a cured resin matrix.

A number of the deficiencies of advanced composites result from limitations of the matrix resins used in the fabrication of the composites. Resin-dependent properties include composite compression strength and shear modulus (which are dependent on the resin modulus) and impact strength (which is dependent on the resin fracture toughness). Various methods of improving these resin-dependent composite properties have been attempted. For example, elastomeric fillers (such as carboxyl-, amino-, or sulfhydryl-terminated polyacrylonitrile-butadiene elastomers) have been incorporated, thermoplastics (such as polyether imides or polysulfones) have been incorporated, and the crosslink density of the matrix resin has been decreased by using monomers of higher molecular weight or lower functionality. Such methods have indeed been effective at increasing resin fracture toughness and composite impact strength. But, unfortunately, the methods have also produced a decrease in the resin modulus and, accordingly, a decrease in the compression strength and shear modulus of composites made from the resins. The methods have tended to degrade the high temperature properties of the composites, as well. Thus, composites prepared by these methods have had to be thicker and therefore heavier in order to exhibit the compressive and shear properties needed for various applications.

Other methods have focused on increasing the modulus of matrix resins as a means of increasing composite compressive and shear properties. For example, “fortifiers” or antiplasticizers have been utilized. Such materials do increase the modulus of cured epoxy networks but also significantly reduce glass transition temperature and increase moisture absorption. Thus, the materials are unsatisfactory for use in high performance composite matrix resins.

Conventional fillers (fillers having a particle size greater than one micron) can also be used to increase the modulus of cured thermosetting resin networks, but such fillers are unsuitable for use in the fabrication of advanced composites for the following reasons. During the curing of a fiber-containing composite composition, resin flow sufficient to rid the composition of trapped air (and thereby enable the production of a composite which is free of voids) is required. As the resin flows, finer denier fibers can act as filter media and separate the conventional filler particles from the resin, resulting in a heterogeneous distribution of filler and cured resin which is unacceptable. Conventional fillers also frequently scratch the surface of the fibers, thereby reducing fiber strength. This can severely reduce the strength of the resulting composite.

Amorphous silica microfibers or whiskers have also been added to thermosetting matrix resins to improve the impact resistance and modulus of composites derived therefrom. However, the high aspect ratio of such microfibers can result in an unacceptable increase in resin viscosity, making processing difficult and also limiting the amount of microfiber that can be added to the matrix resin.

Use of nanoparticles as fillers in resins has been broadly disclosed. However, most of these disclosures have focused on maintaining viscosities of the unfilled resins. In some cases, the unfilled viscosities of the resins are too low for processing with conventional equipment.

Accordingly, there is a need for methods of producing matrix resin systems that are high in both fracture toughness and modulus, and which therefore provide composites exhibiting high toughness as well as high compressive and shear properties. Such methods should also provide an increase in viscosity and easy processability of conventional resin systems. Additionally industrial efforts are focused on reducing cure temperatures and thus enable lower temperature out-of-autoclave processing methods where structures are exposed to lower thermal stress.

### SUMMARY

Curable bisimide resins are fraught with issues pertaining to their low viscosity resulting in excessive flow during cure and the need for elaborate modifications to conventional processing techniques. An example of such modifications includes cure damming procedures. A reduction in resin flow during cure produces higher quality parts and enables better composite design accuracy. Additionally curable bisimide resin sols with lower cure temperatures are desirable because this lower cure temperature increases the range of composite fabrication processes that can be employed, such as out-of-autoclave options. Lower cure temperatures may also influence resulting part quality providing lower thermal expansion and less thermal stress. These lower cure temperatures, while providing mechanical property enhancement occurs without particle filtration due to the size of the silica employed in this invention (ca. 100 nm), a drawback experienced when using conventional micron fillers.

In one aspect the present disclose provides a curable resin sol comprising an essentially volatile-free, colloidal dispersion of substantially spherical nanosilica particles in a curable bisimide resin, said particles having surface-bonded organic groups which render said particles compatible with said curable bisimide resin. In some embodiments, the weight percent the nanosilica particles is equal to or greater than 30 weight percent based on the total weight of the resin sol. In some embodiments, the particles are ion exchanged substantially spherical nanosilica particles. In some embodiments, the sol has a viscosity greater than a curable bisimide resin that does not include nanosilica particles. For example, in some instances, the sol has a change in viscosity of greater than or equal to a 10% increase when compared to the same curable bisimide resin that does not include nanosilica particles.

In some embodiments, the sol contains less than about 2 weight percent of volatile materials. In some embodiments, the nanosilica particles have an average particle diameter in the range of from about 1 nanometer to about 1000 nanometers. In some embodiments, the nanosilica particles have an average particle diameter in the range of about 60 nanometers to about 200 nanometers.

In some embodiments, the curable bisimide resin comprises bismaleimide resin. In some embodiments, the curable bisimide resin comprises at least one additional curable resin selected from at least one of epoxy resins, imide resins, vinyl ester resins, acrylic resins, bisbenzocyclobutane resins, and polycyanate ester resins.

In another aspect, the present disclosure provides a composition comprising (a) a curable resin sol comprising a colloidal dispersion of substantially spherical nanosilica particles in a curable bisimide resin, said nanosilica particles having surface-bonded organic groups which render said nanosilica particles compatible with said curable bisimide resin; and (b) reinforcing fibers. In some embodiments, the weight percent the nanosilica particles is equal to or greater than 30 weight percent based on the total weight of the curable resin sol. In some embodiments, the particles are ion exchanged substantially spherical nanosilica particles. In some embodiments, the sol has a viscosity greater than a curable bisimide resin that does not include nanosilica particles. For example, in some cases, the sol has an increase in viscosity of greater than or equal to a 10% increase when compared to the same bisimide resin that does not include nanosilica particles.

In some embodiments, the surface-bonded organic groups organosilanes. In some embodiments, the reinforcing fibers are continuous. In some embodiments, the reinforcing fibers comprise carbon, glass, ceramic, boron, silicon carbide, polyimide, polyamide, polyethylene, or combinations thereof. In some embodiments, the reinforcing fibers comprise a unidirectional array of individual continuous fibers, woven fabric, knitted fabric, yarn, roving, braided constructions, or non-woven mat.

In some embodiments, the curable bisimide resin content is less than or equal to 32 volume percent based on the total weight of the composition when the reinforcing fibers comprise 61 volume percent. In some embodiments, the curable bisimide resin content is less than or equal to 41 volume percent based on the total weight of the composition when the reinforcing fibers comprise 50 volume percent. In some embodiments, the composition further comprises at least one additive selected from the group consisting of curing agents, cure accelerators, catalysts, crosslinking agents, dyes, flame retardants, pigments, impact modifiers, and flow control agents.

In another aspect, the present disclosure provides a prepreg made using any of the previously disclosed compositions. In another aspect, the present disclosure provides a composite made using any of the previously disclosed compositions. In some embodiments, the nanosilica particles are uniformly distributed throughout the cured composition.

In another aspect, the present disclosure provides a thick article comprising: a cured composition comprising (a) a curable resin sol comprising a colloidal dispersion of substantially spherical nanosilica particles in a curable bisimide resin, said nanosilica particles having surface-bonded organic groups which render said nanosilica particles compatible with said curable bisimide resin; and (b) reinforcing fibers, wherein the thick article comprises at least 30 weight percent of nanosilica particles. In some embodiments, the nanosilica particles are uniformly distributed throughout the cured composition.

In yet another aspect, the present disclosure provides a process for preparing fiber-containing compositions comprising the steps of (a) forming a mixture comprising a curable bisimide resin and at least one organosol, said organosol comprising volatile liquid and substantially spherical nanosilica particles, said nanosilica particles having surface-bonded organic groups which render said nanosilica particles compatible with said curable resin; (b) removing said volatile liquid from said mixture so as to form a curable resin sol; and (c) combining said mixture or said curable resin sol with reinforcing fibers so as to form an essentially volatile-free fiber-containing composition. In some embodiments, the process further comprises the step of curing said fiber-containing composition. In some embodiments, the combining is carried out according to a process selected from the group consisting of resin transfer molding, pultrusion, and filament winding. In some embodiments, a prepreg is prepared by the aforementioned process. In some embodiments, a composite is prepared by the aforementioned process. In some embodiments, an article is made using the composite prepared by the aforementioned process.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 is a graphical representation of the rheological profiles of Example 1 (EX1), Example 2 (EX2) and Comparative Example 1 (CE1).

### DETAILED DESCRIPTION

As used in this specification, the recitation of numerical ranges by endpoints includes all numbers subsumed within that range (e.g. 1 to 5 includes 1, 1.5, 2, 2.75, 3, 3.8, 4, and 5, and the like).

Unless otherwise indicated, all numbers expressing quantities or ingredients, measurement of properties and so forth used in the Specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Curable resins suitable for use in the compositions of the invention are those resins, e.g., thermosetting resins and radiation-curable resins, which are capable of being cured to form a glassy network polymer. Suitable resins include, e.g., epoxy resins, curable imide resins (especially maleimide resins, but also including, e.g., commercial K-3 polyimides (available from duPont) and polyimides having a terminal reactive group such as acetylene, diacetylene, phenylethynyl, norbornene, nadimide, or benzocyclobutane), vinyl ester resins and acrylic resins (e.g., (meth)acrylic esters or amides of polyols, epoxies, and amines), bisbenzocyclobutane resins, polycyanate ester resins, and mixtures thereof. The resins can be utilized in the form of either monomers or prepolymers. In some embodiments, curable resins include curable bisimide resins. These curable bisimide resins may be blended with other curable resins, such as epoxy resins, maleimide resins, polycyanate ester resins, and mixtures thereof.

Curable bisimide resins useful in the present disclosure include maleimide resins. Maleimide resins suitable for use in the compositions of the present disclosure include bismaleimides, polymaleimides, and polyaminobismaleimides. Such maleimides can be conveniently synthesized by combining maleic anhydride or substituted maleic anhydrides with di- or polyamine(s). In some embodiments, useful bisimides are N,N′-bismaleimides, which can be prepared, e.g., by the methods described in U.S. Pat. No. 3,562,223 (Bargain et al.), U.S. Pat. No. 3,627,780 (Bonnard et al.), U.S. Pat. No. 3,839,358 (Bargain), and U.S. Pat. No. 4,468,497 (Beckley et al.) (the descriptions of which are incorporated herein by reference) and many of which are commercially available.

Representative examples of suitable N,N′-bismaleimides include the N,N′-bismaleimides of 1,2-ethanediamine, 1,6-hexanediamine, trimethyl-1,6-hexanediamine, 1,4-benzenediamine, 4,4′-methylenebisbenzenamine, 2-methyl-1,4-benzenediamine, 3,3′-methylenebisbenzenamine, 3,3′-sulfonylbisbenzenamine, 4,4′-sulfonylbisbenzenamine, 3,3′-oxybisbenzenamine, 4,4′-oxybisbenzenamine, 4,4′-methylenebiscyclohexanamine, 1,3-benzenedimethanamine, 1,4-benzenedimethanamine, 4,4′-cyclohexanebisbenzenamine, and mixtures thereof.

Various bismaleimide compounds are disclosed in U.S. Pat. No. 5,985,963, the entire disclosure of which is incorporated herein by reference. Non-limiting examples of bismaleimides that may be used in the present disclosure include N,N′-ethylenebismaleimide, N,N′-hexamethylenebismalemide,N,N′-dodecamethylenebismaleimide, N,N′-(2,2,4-trimethylhexamethylene)bismaleimide, N,N′-(oxy-dipropylene)bismaleimide, N,N′-(aminodipropylene)-bismaleimide, N,N′-(ethylenedioxydipropylene)-bismaleimide, N,N′(1,4-cyclohexylene)bismaleimide, N,N′-(1,3-cyclohexylene)bismaleimide, N,N′-(methylene-1,4-dicyclohexylene)bismaleimide, N,N′-(isopropylidene-1,4-dicyclohexylene)bismaleimide, N,N′-(oxy-1,4-dicyclohexylene)bismaleimide, N,N′-(m-phenylene)bismaleimide, N,N′-p-(phenylene)-bismaleimide, N,N′-(o-phenylene)bismaleimide, N,N′-(1,3-naphthylene)bismaleimide, N,N′-(1,4-naphthylene)-bismaleimide, N,N′-(1,5-naphthylene)bismaleimide, N,N-(3,3′-dimethyl-4,4′-diphenylene)bismaleimide, N,N′-(3,3-dichloro-4,4′-biphenylene)bismaleimide, N,N′-(2,4-pyridyl)bismaleimide, N,N′-(2,6-pyridyl)-bismaleimide, N,N′-(m-tolylene)bismaleimide, N,N′-(p-tolylene)bismaleimide, N,N′-(4,6-dimethyl-1,3-phenylene)bismaleimide, N,N′-(2,3-dimethyl-1,4-phenylene)bismaleimide, N,N′-(4,6-dichloro-1,3-phenylene)bismaleimide, N,N′-(5-chloro-1,3-phenylene)-bismaleimide, N,N′-(5-hydroxy-1,3-phenylene)-bismaleimide, N,N′-(5-methoxy-1,3-phenylene)-bismaleimide, N,N′-(m-xylylene)bismaleimide, N,N′-(p-xylylene)bismaleimide, N,N′-(methylenedi-p-phenylene)-bismaleimide, N,N′-(isopropylidenedi-p-phenylene)-bismaleimide, N,N′-(oxydi-p-phenylene)bismaleimide, N,N′-(thiodi-p-phenylene)bismaleimide, N,N-(dithiodi-p-phenylene)bismaleimide, N,N′-(sulfodi-p-phenylene)-bismaleimide, N,N′-(carbonyldi-p-phenylene)-bismaleimide, α-bis-(4-maleimidophenyl)-meta-diisopropylbenzene, α-bis-(4-p-phenylene)bismaleimide, N,N′-m-xylylene-bis-citraconic imide and α-bis-(4-maleimidophenyl)-para-diisopropylbenzene. In one embodiment, the bismaleimide is N,N′-(m-phenylene)bismaleimide, available from DuPont under the trade designation “HVA”.

Co-reactants for use with the bismaleimides can include any of a wide variety of unsaturated organic compounds, particularly those having multiple unsaturation, either ethylenic, acetylenic, or both. Examples include (meth)acrylic acid and (meth)acrylamide and derivatives thereof, e.g., (methyl)methacrylate; dicyanoethylene; tetracyanoethylene; allyl alcohol; 2,2′-diallylbisphenol A; 2,2′-dipropenylbisphenol A; diallylphthalate; triallylisocyanurate; triallylcyanurate; N-vinyl-2-pyrrolidinone; N-vinyl caprolactam; ethylene glycol dimethacrylate; diethylene glycol dimethacrylate; trimethylolpropane triacrylate; trimethylolpropane trimethacrylate; pentaerythritol tetramethacrylate; 4-allyl-2-methoxyphenol; triallyl trimellitate; divinyl benzene; dicyclopentadienyl acrylate; dicyclopentadienyloxyethyl acrylate; 1,4-butanediol divinyl ether; 1,4-dihydroxy-2-butene; styrene; a-methyl styrene; chlorostyrene; p-phenylstyrene; p-methylstyrene; t-butylstyrene; and phenyl vinyl ether. Of particular interest are resin systems employing a bismaleimide in combination with a bis(alkenylphenol). Descriptions of a typical resin system of this type are found in U.S. Pat. No. 4,100,140 (Zahir et al.), the descriptions of which are incorporated herein by reference. In some embodiments, particularly useful components are 4,4′-bismaleimidodiphenylmethane and o,o′-diallyl bisphenol A.

Epoxy resins useful to blend with the presently disclosed bismaleimide resins are those epoxy resins well-known in the art, such as those that comprise compounds or mixtures of compounds which contain one or more epoxy groups of the structure:

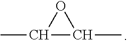

The compounds can be saturated or unsaturated, aliphatic, alicylic, aromatic, or heterocyclic, or can comprise combinations thereof. Compounds which contain more than one epoxy group (i.e., polyepoxides) are useful in some embodiments.

Polyepoxides which can be utilized in the compositions of the invention include, e.g., both aliphatic and aromatic polyepoxides, but aromatic polyepoxides are useful for high temperature applications. The aromatic polyepoxides are compounds containing at least one aromatic ring structure, e.g. a benzene ring, and more than one epoxy group. In some embodiments, aromatic polyepoxides include the polyglycidyl ethers of polyhydric phenols (e.g., bisphenol A derivative resins, epoxy cresol-novolac resins, bisphenol F derivative resins, epoxy phenol-novolac resins), glycidyl esters of aromatic carboxylic acids, and glycidyl amines of aromatic amines. In some embodiments, useful aromatic polyepoxides are the polyglycidyl ethers of polyhydric phenols.

Representative examples of aliphatic polyepoxides which can be utilized in the compositions of the invention include 3′,4′ epoxycyclohexylmethyl-3,4 epoxycyclohexanecarboxylate, 3,4-epoxycyclohexyloxirane, 2-(3′,4′-epoxycyclohexyl)-5,1″-spiro-3″,4″-epoxycyclohexane-1,3-dioxane, bis(3,4-epoxycyclohexylmethyl)adipate, the diglycidyl ester of linoleic dimer acid, 1,4-bis(2,3-epoxypropoxy)butane, 4-(1,2-epoxyethyl)-1,2-epoxycyclohexane, 2,2-bis(3,4-epoxycyclohexyl)propane, polyglycidyl ethers of aliphatic polyols such as glycerol or hydrogenated 4,4′-dihydroxydiphenyl-dimethylmethane, and mixtures thereof.

Representative examples of aromatic polyepoxides which can be utilized in the compositions of the invention include glycidyl esters of aromatic carboxylic acids, e.g., phthalic acid diglycidyl ester, isophthalic acid diglycidyl ester, trimellitic acid triglycidyl ester, and pyromellitic acid tetraglycidyl ester, and mixtures thereof; N-glycidylaminobenzenes, e.g., N,N-diglycidylbenzeneamine, bis(N,N-diglycidyl-4-aminophenyl)methane, 1,3-bis(N,N-diglycidylamino)benzene, and N,N-diglycidyl-4-glycidyloxybenzeneamine, and mixtures thereof; and the polyglycidyl derivatives of polyhydric phenols, e.g., 2,2-bis-[4-(2,3-epoxypropoxy)phenyl]propane, the polyglycidyl ethers of polyhydric phenols such as tetrakis(4-hydroxyphenyl)ethane, pyrocatechol, resorcinol, hydroquinone, 4,4′-dihydroxydiphenyl methane, 4,4′-dihydroxydiphenyl dimethyl methane, 4,4′-dihydroxy-3,3′-dimethyldiphenyl methane, 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris-(4-hydroxyphenyl)methane, polyglycidyl ethers of novolacs (reaction products of monohydric or polyhydric phenols with aldehydes in the presence of acid catalysts), and the derivatives described in U.S. Pat. No. 3,018,262 (Schoeder) and U.S. Pat. No. 3,298,998 (Coover et al.), the descriptions of which are incorporated herein by reference, as well as the derivatives described in the Handbook of Epoxy Resins by Lee and Neville, McGraw-Hill Book Co., New York (1967) and in Epoxy Resins, Chemistry and Technology, Second Edition, edited by C. May, Marcel Dekker, Inc., New York (1988), and mixtures thereof. In some embodiments, a class of polyglycidyl ethers of polyhydric phenols useful in the presently disclosed compositions are the diglycidyl ethers of bisphenol that have pendant carbocyclic groups, e.g., those described in U.S. Pat. No. 3,298,998 (Coover et al.), the description of which is incorporated herein by reference. Examples of such compounds include 2,2-bis[4-(2,3-epoxypropoxy)phenyl]norcamphane and 2,2-bis[4-(2,3-epoxypropoxy)phenyl]decahydro-1,4,5,8- [symbol] dimethanonaphthalene. In some embodiments, 9,9-bis[4-(2,3-epoxypropoxy)phenyl]fluorine is used.

Suitable epoxy resins can be prepared by, e.g., the reaction of epichlorohydrin with a polyol, as described, e.g., in U.S. Pat. No. 4,522,958 (Das et al.), the description of which is incorporated herein by reference, as well as by other methods described by Lee and Neville and by May, supra. Many epoxy resins are also commercially available.

Polycyanate ester resins suitable for use in the presently disclosed blend compositions can be prepared by combining cyanogen chloride or bromide with an alcohol or phenol. The preparation of such resins and their use in polycyclotrimerization to produce polycyanurates are described in U.S. Pat. No. 4,157,360 (Chung et al.), the descriptions of which are incorporated herein by reference. Representative examples of suitable polycyanate ester resins include 1,2-dicyanatobenzene, 1,3-dicyanatobenzene, 1,4-dicyanatobenzene, 2,2′-dicyanatodiphenylmethane, 3,3′-dicyanatodiphenylmethane, 4,4′-dicyanatodiphenylmethane, and the dicyanates prepared from biphenol A, bisphenol F, and bisphenol S. Tri- and higher functionality cyanate resins are also suitable.

In some embodiments, the resin content useful in the present disclosure can vary depending on the type of reinforcing fibers used in the composition. For example, the resin content useful in the present disclosure includes a curable resin content of less than or equal to 35 wt % based on the total weight of the composition when the reinforcing fibers comprise carbon. In some embodiments, the resin content useful in the present disclosure includes a curable bisimide resin content is less than or equal to 25 wt % based on the total weight of the composition when the reinforcing fibers comprise glass.

Nanoparticles suitable for use in the presently disclosed compositions and articles are substantially spherical in shape, colloidal in size (e.g., having an average particle diameter in the range of from about 1 nanometer (1 millimicron) to about 1 micrometer (1 micron)), and substantially inorganic in chemical composition. Colloidal silica is useful, but other colloidal metal oxides, e.g., colloidal titania, colloidal alumina, colloidal zirconia, colloidal vanadia, colloidal chromia, colloidal iron oxide, colloidal antimony oxide, colloidal tin oxide, and mixtures thereof, can also be utilized. The colloidal nanoparticles can comprise essentially a single oxide such as silica or can comprise a core of an oxide of one type (or a core of a material other than a metal oxide) on which is deposited an oxide of another type. Generally, the nanoparticles can range in size (average particle diameter) from about 1 nanometers to about 1000 nanometers, preferably from about 60 nanometers to about 200 nanometers.

It is also useful for the colloidal nanoparticles to be relatively uniform in size and remain substantially non-aggregated, as nanoparticle aggregation can result in precipitation, gellation, or a dramatic increase in sol viscosity. Thus, a particularly desirable class of nanoparticles for use in preparing the compositions of the invention includes sols of inorganic nanoparticles (e.g., colloidal dispersions of inorganic nanosilica particles in liquid media), especially sols of amorphous silica. Such sols can be prepared by a variety of techniques and in a variety of forms which include hydrosols (where water serves as the liquid medium), organosols (where organic liquids are used), and mixed sols (where the liquid medium comprises both water and an organic liquid). See, e.g., the descriptions of the techniques and forms given in U.S. Pat. No. 2,801,185 (Iler) and U.S. Pat. No. 4,522,958 (Das et al.), which descriptions are incorporated herein by reference, as well as those given by R. K. Iler in The Chemistry of Silica, John Wiley & Sons, New York (1979).

Due to their surface chemistry and commercial availability, silica hydrosols are useful for preparing the compositions of the invention. Such hydrosols are available in a variety of particle sizes and concentrations from, e.g., Nyacol Products, Inc. in Ashland, Md.; Nalco Chemical Company in Oakbrook, Ill.; and E. I. duPont de Nemours and Company in Wilmington, Del. Concentrations of from about 10 to about 50 percent by weight of silica in water are generally useful, with concentrations of from about 23 to about 56 volume percent (30 to about 50 weight percent) being useful in some embodiments (as there is less water to be removed). If desired, silica hydrosols can be prepared, e.g., by partially neutralizing an aqueous solution of an alkali metal silicate with acid to a pH of about 8 or 9 (such that the resulting sodium content of the solution is less than about 1 percent by weight based on sodium oxide). Other methods of preparing silica hydrosols, e.g., electrodialysis, ion exchange of sodium silicate, hydrolysis of silicon compounds, and dissolution of elemental silicon are described by Iler, supra. In some embodiments, a useful method of preparing the presently disclosed nanosilica particles includes ion exchanging the particles before including them in the curable resin sol.

In preparing the presently disclosed compositions, a curable resin sol can generally be prepared first and then combined with reinforcing fibers. Preparation of the curable resin sol generally requires that at least a portion of the surface of the inorganic nanosilica particles be modified so as to aid in the dispersibility of the nanosilica particles in the resin. This surface modification can be effected by various different methods which are known in the art. (See, e.g., the surface modification techniques described in U.S. Pat. No. 2,801,185 (Iler) and U.S. Pat. No. 4,522,958 (Das et al.), which descriptions are incorporated herein by reference.)

For example, silica nanoparticles can be treated with monohydric alcohols, polyols, or mixtures thereof (preferably, a saturated primary alcohol) under conditions such that silanol groups on the surface of the particles chemically bond with hydroxyl groups to produce surface-bonded ester groups. The surface of silica (or other metal oxide) particles can also be treated with organosilanes, e.g, alkyl chlorosilanes, trialkoxy arylsilanes, or trialkoxy alkylsilanes, or with other chemical compounds, e.g., organotitanates, which are capable of attaching to the surface of the particles by a chemical bond (covalent or ionic) or by a strong physical bond, and which are chemically compatible with the chosen resin(s). In some embodiments, treatment with organosilanes is useful. When aromatic ring-containing epoxy resins are utilized, surface treatment agents which also contain at least one aromatic ring are generally compatible with the resin.

In preparing the curable resin sols, a hydrosol (e.g., a silica hydrosol) can generally be combined with a water-miscible organic liquid (e.g., an alcohol, ether, amide, ketone, or nitrile) and, optionally (if alcohol is used as the organic liquid), a surface treatment agent such as an organosilane or organotitanate. Alcohol and/or the surface treatment agent can generally be used in an amount such that at least a portion of the surface of the nanoparticles is modified sufficiently to enable the formation of a stable curable resin sol (upon combination with curable resin, infra). Preferably, the amount of alcohol and/or treatment agent is selected so as to provide particles which are at least about 50 weight percent metal oxide (e.g., silica), more preferably, at least about 75 weight percent metal oxide. (Alcohol can be added in an amount sufficient for the alcohol to serve as both diluent and treatment agent.) The resulting mixture can then be heated to remove water by distillation or by azeotropic distillation and can then be maintained at a temperature of, e.g., about 100° C. for a period of, e.g., about 24 hours to enable the reaction (or other interaction) of the alcohol and/or other surface treatment agent with chemical groups on the surface of the nanoparticles. This provides an organosol comprising nanoparticles which have surface-attached or surface-bonded organic groups (“substantially inorganic” nanoparticles).

The resulting organosol can then be combined with a curable resin and the organic liquid removed by, e.g., using a rotary evaporator. (The removal of the organic liquid can, alternatively, be delayed until after combination with reinforcing fibers, if desired.) Preferably, the organic liquid is removed by heating under vacuum to a temperature sufficient to remove even tightly-bound volatile components. Stripping times and temperatures can generally be selected so as to maximize removal of volatiles while minimizing advancement of the resin. Failure to adequately remove volatiles at this stage leads to void formation during the curing of the composition, resulting in deterioration of thermomechanical properties in the cured composites. (This is a particularly severe problem in the fabrication of structural composites, where the presence of voids can have a disastrous effect on physical properties.) Unremoved volatiles can also plasticize the cured resin network and thereby degrade its high temperature properties. Generally, resin sols having volatile levels less than about 2 weight percent (preferably, less than about 1.5 weight percent) provide void-free composites having the desired thermomechanical properties.

Removal of volatiles can result in gel formation (due to loss of any surface-bound volatiles), if the above-described surface treatment agent is not properly chosen so as to be compatible with the curable resin, if the agent is not tightly-bound to the microparticle surface, and/or if an incorrect amount of agent is used. As to compatibility, the treated particle and the resin should generally have a positive enthalpy of mixing to ensure the formation of a stable sol. (Solubility parameter can often be conveniently used to accomplish this by matching the solubility parameter of the surface treatment agent with that of the curable resin.) Removal of the volatiles provides curable resin sols, which can generally contain from about 3 to about 50 volume percent (preferably, from about 4 to about 30 volume percent) substantially inorganic nanoparticles.

The presently disclosed compositions can be prepared by combining the curable resin sol with reinforcing fibers (preferably, continuous reinforcing fibers). Suitable fibers include both organic and inorganic fibers, e.g., carbon or graphite fibers, glass fibers, ceramic fibers, boron fibers, silicon carbide fibers, polyimide fibers, polyamide fibers, polyethylene fibers, and the like, and combinations thereof. Fibers of carbon, glass, or polyamide are useful due to considerations of cost, physical properties, and processability. Such fibers can be in the form of a unidirectional array of individual continuous fibers, woven fabric, knitted fabric, yarn, roving, braided constructions, or non-woven mat. Generally, the compositions can contain, e.g., from about 30 to about 80 (preferably, from about 45 to about 70) volume percent fibers, depending upon structural application requirements.

The compositions can further comprise additives such as curing agents, cure accelerators, catalysts, crosslinking agents, dyes, flame retardants, pigments, impact modifiers (e.g., rubbers or thermoplastics), and flow control agents. Epoxy resins can be cured by a variety of curing agents, some of which are described (along with a method for calculating the amounts to be used) by Lee and Neville in Handbook of Epoxy Resins, McGraw-Hill, pages 36-140, New York (1967). Useful epoxy resin curing agents include polyamines such as ethylenediamine, diethylenetriamine, aminoethylethanolamine, and the like, diaminodiphenylsulfone, 9,9-bis(4-aminophenyl)fluorene, 9,9-bis(3-chloro-4-(aminophenyl)fluorene, amides such as dicyandiamide, polycarboxylic acids such as adipic acid, acid anhydrides such as phthalic anhydride and chlorendic anhydride, and polyphenols such as bisphenol A, and the like. Generally, the epoxy resin and curing agent are used in stoichiometric amounts, but the curing agent can be used in amounts ranging from about 0.1 to 1.7 times the stoichiometric amount of epoxy resin.

Thermally-activated catalytic agents, e.g., Lewis acids and bases, tertiary amines, imidazoles, complexed Lewis acids, and organometallic compounds and salts, can also be utilized in curing epoxy resins. Thermally-activated catalysts can generally be used in amounts ranging from about 0.05 to about 5 percent by weight, based on the amount of curable bisimide resin present in the curable resin composition.

N,N′-bismaleimide resins can be cured using diamine curing agents, such as those described in U.S. Pat. No. 3,562,223 (Bargain et al.), the description of which is incorporated herein by reference. Generally, from about 0.2 to about 0.8 moles of diamine can be used per mole of N,N′-bismaleimide. N,N′-bismaleimides can also cure by other mechanisms, e.g., co-cure with aromatic olefins (such as bis-allylphenyl ether, 4,4′-bis(o-propenylphenoxy)benzophenone, or o,o′-diallyl bisphenol A) or thermal cure via a self-polymerization mechanism.

Polycyanate resins can be cyclotrimerized by application of heat and/or by using catalysts such as zinc octoate, tin octoate, zinc stearate, tin stearate, copper acetylacetonate, and chelates of iron, cobalt, zinc, copper, manganese, and titanium with bidentate ligands such as catechol. Such catalysts can generally be used in amounts of from about 0.001 to about 10 parts by weight per 100 parts of polycyanate ester resin.

The curable resin sols of the compositions of the present disclosure can be used to make composite articles by a variety of conventional processes, e.g., resin transfer molding, filament winding, tow placement, resin infusion processes, or traditional prepreg processes. Prepregs can be prepared by impregnating an array of fibers (or a fabric) with the resin sol (or with a volatile organic liquid-containing resin sol) and then layering the impregnated tape or fabric. The resulting prepreg can then be cured by application of heat, along with the application of pressure or vacuum (or both) to remove any trapped air.

The curable resin sols can also be used to make composite parts by a resin transfer molding process, which is widely used to prepare composite parts for the aerospace and automotive industries. In this process, fibers are first shaped into a preform which is then compressed to final part shape in a metal mold. The sol can then be pumped into the mold and heat-cured. Both a consistent resin viscosity and a small particle size (less than 1 micron in average diameter) are important for this process so that the sol can flow through the compressed preform in a short amount of time, without particle separation or preform distortion.

Composites can also be prepared from the curable resin sols by a filament winding process, which is typically used to prepare cylinders or other composites having a circular or oval cross-sectional shape. In this process, a fiber tow or an array of tows is impregnated with the sol by running it through a resin bath and immediately winding the impregnated tow onto a mandrel. The resulting composite can then be heat-cured.

A pultrusion process (a continuous process used to prepare constant cross-section parts) can also be used to make composites from the curable resin sols. In such a process, a large array of continuous fibers is first wetted out in a resin bath. The resulting wet array is then pulled through a heated die, where trapped air is squeezed out and the resin is cured.

In all of the foregoing processing techniques, it is desirable to provide a curable bisimide resin sol containing nanosilica particles that has a viscosity greater than a curable bisimide resin that does not include nanosilica particles. This allows for processing of bisimide resin sols on conventional processing equipment without the use of elaborate modifications to conventional processing techniques, such as cure damming procedures. A reduction in curable bisimide resin sol flow during cure due to these relatively higher viscosities produces higher quality parts and enables better composite design accuracy. For example, in some embodiments, it is useful for the curable bisimide resin sol to have an increase in viscosity of 10% when compared to a curable bisimide resin that does not include nanosilica particles.

The compositions of the present disclosure have sufficient viscosity that they are readily processable, e.g., by hot-melt techniques. The rheological and curing characteristics of the compositions can be adjusted to match those required for a particular composite manufacturing process. The compositions can be cured by application of heat, electron beam radiation, microwave radiation, or ultraviolet radiation to form fiber-reinforced composites which exhibit improved compression strength and/or shear modulus and improved impact behavior (relative to the corresponding cured compositions without nanoparticles). This makes the composites well-suited for use in applications requiring structural integrity, e.g., applications in the transportation, construction, and sporting goods industries. Some exemplary applications in which the presently disclosed composites are useful include tooling, molding, high capacity conductors, polymer composite conductors, electrical transmission lines, and the like.

In some embodiment, it is desirable to use the presently disclosed curable resin sols and compositions to make cured thick articles (or composites). As used herein the term “thick” means greater than 5 cm, in some embodiments greater than 10 cm, in some embodiments greater than 15 cm. Exemplary thick articles include tooling molds made using the presently disclosed curable resin sols and compositions.

For presently disclosed cured compositions (i.e. composites), including the presently disclosed thick articles, it is desirable for the nanosilica particles to be uniformly distributed throughout the cured composition. The term “uniformly distributed” as used herein means that the nanosilica particle distribution within any given 3 dimensional cross section of the cured compositions does not show evidence of particle agglomeration. Rather, it is desirable for the nanosilica particles to be evenly spaced throughout such a3 dimensional cross section of the cured compositions.
1. A curable resin sol comprising an essentially volatile-free, colloidal dispersion of substantially spherical nanosilica particles in a curable bisimide resin, said particles having surface-bonded organic groups which render said particles compatible with said curable bisimide resin.
2. The sol of claim 1 wherein the weight percent the nanosilica particles is equal to or greater than 30 weight percent.
3. The sol of any of the preceding claims wherein the particles are ion exchanged substantially spherical nanosilica particles.
4. The sol of any of the preceding claims wherein the sol has a viscosity greater than the same curable bisimide resin that does not include nanosilica particles.
5. The sol of any of claim 4 wherein the sol has an increase in viscosity of greater than or equal to a 10% increase when compared to the same curable bisimide resin that does not include nanosilica particles.
6. The sol of any of the preceding claims wherein said sol contains less than about 2 weight percent of volatile materials.
7. The sol of any of the preceding claims wherein said nanosilica particles have an average particle diameter in the range of from about 1 nanometer to about 1000 nanometers.
8. The sol of claim 7 wherein said nanosilica particles have an average particle diameter in the range of about 60 nanometers to about 200 nanometers.
9. The sol of any of the preceding claims wherein the curable bisimide resin comprises bismaleimide resin.
10. The sol of any of claim 9 wherein the curable bisimide resin comprises at least one additional curable resin selected from at least one of epoxy resins, imide resins, vinyl ester resins, acrylic resins, bisbenzocyclobutane resins, and polycyanate ester resins.
11. A composition comprising (a) a curable resin sol comprising a colloidal dispersion of substantially spherical nanosilica particles in a curable bisimide resin, said nanosilica particles having surface-bonded organic groups which render said nanosilica particles compatible with said curable bisimide resin; and (b) reinforcing fibers.
12. The composition of claim 11 wherein the weight percent the nanosilica particles is equal to or greater than 30 weight percent of the curable resin sol.
13. The composition of any of claims 11 to 12 wherein the particles are ion exchanged substantially spherical nanosilica particles.
14. The composition of any of claims 11 to 13 wherein the sol has a viscosity greater than the same curable bisimide resin that does not include nanosilica particles.
15. The composition of any of claims 11 to 14 wherein the sol has an increase in viscosity greater than or equal to a 10% increase when compared to the same bisimide resin that does not include nanosilica particles.
16. The composition of any of claims 11 to 15 wherein said composition contains less than about 2 weight percent of volatile materials.
17. The composition of any of claims 11 to 16 wherein said nanosilica particles have an average particle diameter in the range of from about 1 nanometer to about 1000 nanometers.
18. The composition of claim 17 wherein said nanosilica particles have an average particle diameter in the range of about 60 nanometers to about 200 nanometers.
19. The composition of any of claims 11 to 18 wherein the curable bisimide resin comprises bismaleimide resin.
20. The composition of any of claims 11 to 19 wherein the curable bisimide resin comprises at least one additional curable resin selected from at least one of epoxy resins, mide resins, vinyl ester resins, acrylic resins, bisbenzocyclobutane resins, and polycyanate ester resins.
21. The composition of any of claims 11 to 20 wherein said surface-bonded organic groups organosilanes.
22. The composition of any of claims 11 to 21 wherein said reinforcing fibers are continuous.
23. The composition of any of claims 11 to 22 wherein said reinforcing fibers comprise carbon, glass, ceramic, boron, silicon carbide, polyimide, polyamide, polyethylene, or combinations thereof.
24. The composition of any of claims 11 to 23 wherein said reinforcing fibers comprise a unidirectional array of individual continuous fibers, woven fabric, knitted fabric, yarn, roving, braided constructions, or non-woven mat.
25. The composition of claim 23 wherein the curable bisimide resin content is less than or equal to 32 volume percent based on the total weight of the composition when the reinforcing fibers comprise 61 volume percent.
26. The composition of claim 23 wherein the curable bisimide resin content is less than or equal to 41 volume percent based on the total weight of the composition when the reinforcing fibers comprise 50 volume percent.
27. The composition of any of claims 11 to 26 further comprising at least one additive selected from the group consisting of curing agents, cure accelerators, catalysts, crosslinking agents, dyes, flame retardants, pigments, impact modifiers, and flow control agents.
28. A prepreg comprising the composition of any of claims 11 to 27.
29. A composite comprising the cured composition of any of claims 11 to 27.
30. The composite of claim 29 wherein the nanosilica particles are uniformly distributed throughout the cured composition.
31. A thick article comprising: a cured composition comprising (a) a curable resin sol comprising a colloidal dispersion of substantially spherical nanosilica particles in a curable bisimide resin, said nanosilica particles having surface-bonded organic groups which render said nanosilica particles compatible with said curable bisimide resin; and (b) reinforcing fibers, wherein the thick article comprises at least 30 weight percent of nanosilica particles based on the total weight of the curable resin sol.
32. The thick article of claim 31 wherein the nanosilica particles are uniformly distributed throughout the cured composition.
33. A process for preparing fiber-containing compositions comprising the steps of (a) forming a mixture comprising a curable bisimide resin and at least one organosol, said organosol comprising volatile liquid and substantially spherical nanosilica particles, said nanosilica particles having surface-bonded organic groups which render said nanosilica particles compatible with said curable resin; (b) removing said volatile liquid from said mixture so as to form a curable resin sol; and (c) combining said mixture or said curable resin sol with reinforcing fibers so as to form an essentially volatile-free fiber-containing composition.
34. The process of claim 33 further comprising the step of curing said fiber-containing composition.
35. The process of claim 33 wherein said combining is carried out according to a process selected from the group consisting of resin transfer molding, pultrusion, and filament winding.
36. A prepreg prepared by the process of claim 33.
37. A composite prepared by the process of claim 33.
38. An article comprising the composite of claim 37.

Objects and advantages of this invention are further illustrated by the following examples, but the particular materials and amounts thereof recited in these examples, as well as other conditions and details, should not be construed to unduly limit this invention. In the examples, all temperatures are in degrees Centigrade and all parts and percentages are by weight unless indicated otherwise.

Various modifications and alterations of this invention will become apparent to those skilled in the art without departing from the scope and spirit of this invention.

### Test Methods

### Rheological DynamicAnalyses (RDA)

Rheological dynamic analyses of uncured resins were run on an ARES rheometer (TA Instruments, New Castle, Del.) in parallel plate dynamic mode using top and bottom plates having a diameter of 50 mm, a gap setting of 1 mm, a temperature range of 50 to 180° C., a heating rate of 2° C./min., a frequency of 1 Hz, and a strain of 2%. Auto strain was used.

### Differential Scanning Calorimetry (DSC)

The cure exotherm of the uncured resins was measured according to ASTM D 3418-08 with the following modificatiom. A TA Q2000 differential scanning calorimeter (TA Instruments) was employed and the samples were prepared in sealed pans and heated in air from −30° C. to 330° C. at 10° C./min. This temperature range is smaller than the temperature range specified in ASTM D 3418-08.

### Linear Shrinkage

Linear shrinkage of resins during cure was measured according to ASTM D 2566-86. The interior surfaces of a semi-cylindrical steel trough mold measuring 2.54 cm in diameter and 25.4 cm in length were coated with a mold release agent. The mold was then preheated to 150° C. after which the liquid resin was poured into the mold and cured as follows. Thirty minutes at 150° C.; then heated at 0.25° C./min. to 180° C.; 4 hours at 180° C.; then heated at to 250° C. over 20 minutes; 6 hour post cure at 250° C. by ramping to this temperature over 20 minutes. Upon cooling to room temperature, the cured resin length and the mold length were measured and linear shrinkage was calculated.

### Thermogravimetric Analysis (TGA)

The silica content of a cured resin of EX1 and EX 2 was measured using a TA Instruments TGA 500 thermogravimetric analyzer (TA Instruments) and heating a 5 to 10 mg sample in air from 30° C. to 850° C. at 20° C./min. The noncombustible residue was taken to be the original nanosilica content of the resin.

### Dynamic Mechanical Analysis (DMA)

The flexural storage modulus (E′) and glass transition temperature (T_{g}) of cured resins were obtained by Dynamic Mechanical Analysis (DMA) using an RSA-2 Solids Analyzer (Rheometrics Scientific, Inc, Piscataway, N.J.) in the dual cantilever beam mode, with a frequency of 1 Hz, a strain of 0.03 to 0.10%, and heating from −30° C. to 300° C. at 5° C./min. The peak of the tan delta curve was reported as the T_{g}.

### Hardness

Barcol hardness (H_{B}) was measured according to ASTM D 2583-95 (Reapproved 2001). A Barcol Impressor (Model GYZJ-934-1, available from Barber-Colman Company, Leesburg, Va.) was employed. For each test specimen, between 5 and 10 measurements were made and the average value was reported.

### Fracture Toughness (K_{1c})

Fracture toughness was measured according to ASTM D5045-99 using a compact tension geometry, wherein the test specimens had nominal dimensions of 3.18 cm by 3.05 cm by 0.64 cm with W=2.54 cm, a=1.27 cm, and B=0.64 cm. A modified loading rate of 1.3 mm/min. (0.050 in/min.) was used.

### Tensile Properties

The room temperature tensile strengths, failure strains, and moduli of the cured resins were measured according to ASTM D638 using a “Type I” specimen. The loading rate was 1.3 mm/min. (0.05 in/min.). Five specimens were tested for each silica concentration level.

### Coefficient of Thermal Expansion

Coefficient of thermal expansion (CTE) measurements were performed using a TMA Q400 (TA Instruments) with a macroexpansion probe. A force of 1.0 N was applied and the specimen lengths were measured at room temperature. The specimens were cycled 10 times from 25° C. to 180° C. The CTE was recorded as a curve fit from 0° C. to 180° C. on the fifth heat.

### Nanoindentation

Nanoindentation studies were performed using an MTS Nanoindenter XP with a DCM module using Continuous Stiffness Measurement (CSM). Load and displacement of the indenter probe into the surface was used to calculate the sample modulus and hardness over hundreds of depths for a single indentation. Each sample was loaded to a maximum force of ca. 17 mN. A Berkovich diamond probe was used to determine the modulus and hardness. Data was averaged over indentation depths from 500-1000 nm. Modulus, Hardness and Vickers hardness were obtained through this method.

### Carbon Fiber Composite Test Methods

Compression strength of the composite laminates was measured according to the Suppliers of Advanced Composite Materials Association recommended method SRM 1R-94 “Recommended Test Method for Compressive Properties of Oriented Fiber-Resin Composites.” Tabs were cut from twelve-ply laminates of a common commercial carbon fiber prepreg tape made using a [0, 90]₃ₛ lay-up. The tabs were bonded using a scrimmed epoxy film adhesive AF163-2 (3M, Saint Paul, Minn.) so that a consistent gage section of 4.75 mm was obtained. A “Modified ASTM D695” test fixture (Wyoming Test Fixtures, Inc., Salt Lake City, Utah) was used with bolt torques of 113 N-cm. A spherically-seated lower platen and a fixed upper platen were used to compress the specimens at a rate of 1.27 mm/min. Nine specimens of each laminate were tested. In-plane shear modulus was determined by the procedure of ASTM D3518. Eight specimens were tested from each panel. A biaxial extensometer was employed. Following the standard, the shear modulus was taken to be the chord modulus between 2,000 and 6,000 micro-shear-strain.

Materials

| | |
|---|---|
| Homide | o,o′-Diallylbisphenol A (DABA), available under the trade |
| 127A | designation “Homide 127A” from HOS-Technik GmbH, |
| | St. Stefan, Austria. |
| MpOH | 1-methoxy-2-propanol, available from Aldrich Chemicals, |
| | Milwaukee, WI. |
| MX 660 | Kane Ace MX 660, a siloxane based 100 nm particle size |
| | core-shell rubber dispersed in Homide 127A at 25 wt %, |
| | Kaneka Texas Corporation, Houston, TX. |
| Matrimid | 4,4′-bismaleimidodiphenylmethane, available under the trade |
| 5292A | designation “Matrimid 5292A” from Huntsman Advanced |
| | Materials, The Woodlands, Texas. |
| Matrimid | o,o′-Diallylbisphenol A (DABA), available under the trade |
| 5292B | designation “Matrimid 5292B” from Huntsman Advanced |
| | Materials, The Woodlands, Texas. |
| Organosol | A ca. 25 wt % solution of phenyltrimethoxysilane/modified |
| 1 (Os 1) | Nalco 2329K (ca. 86 nm particle size) (Nalco Chemical |
| | Company, Naperville, IL) in methoxypropanol/water (50/50 |
| | weight ratio). Phenyltrimethoxysilane modification was |
| | performed according to methods outlined in pending US |
| | patent application US 20110021797. |
| Organosol | A ca. 22 wt % solution of phenyltrimethoxysilane/modified |
| 2 (Os 2) | Nalco TX15502 (ca. 140 nm particle size) (Nalco |
| | Chemical Company, Naperville, IL) in methoxypropanol/water |
| | (50/50 weight ratio). Phenyltrimethoxysilane modification was |
| | performed according to methods outlined in |
| | US patent application US 20110021797. |
| Organosol | A ca. 22 wt % solution of phenyltrimethoxysilane/ |
| 3 (Os 3) | Tmodified Nalco X15502 |
| | (ca. 140 nm particle size) (Nalco Chemical Company, |
| | Naperville, IL) in methoxypropanol/water (50/50 weight ratio). |
| | Ion exchange was performed according to procedures described |
| | in WO 2009152301. Phenyltrimethoxysilane modification was |
| | performed according to methods outlined in pending US patent |
| | application US 20110021797. |

### Wiped Film Evaporator (“WFE”)

Experiments were conducted using a 1 m² counter current polymer processing machine commercially available under the trade designation “Filmtruder” from Buss-SMS-Canzler, Prattleln, Switzerland, that was equipped with a with a 25 hp drive. Steam heat was applied and vapors were condensed using a 2.9 m² stainless steel condenser, designed for low-pressure drop, with an integral jacket and level tank, rated for full vacuum and −38° C. Product flow to the WFE was controlled by a BP-6 Series High Flow Back Pressure Regulator (CO Regulator, Spartanburg, S.C.). The bottom of the WFE was equipped with a 45/45 jacketed polymer pump and drive commercially available under the trade designation “Vacorex” from Maag Automatik, Incorporated, Charlotte, N.C. Vacuum was applied to the system by means of a KDH-130-B vacuum pump commercially available under the trade designation “Kinney” from Tuthill Vacuum and Blower Systems (Springfield, Missouri) and monitored using a Rosemount 3051 Pressure Transmitter (Rosemount, Incorporated, Chanhassen, Minn.). The WFE rotor design consisted of a material-lubricated bearing with an extended rotor apparatus which conveyed materials to the feed throat of the vacuum pump. The rotor extension was used to ensure proper removal of the devolitilized materials from the WFE. The distance from the pump gears to the bottom of the rotor extension bolt head is 5.84 cm.

### Preparation of Nanoparticle Containing Precursor

Precursor for Example 1: A mixture of Os 1/Homide 127A/MX 660 was prepared by mixing the materials and amounts shown in Table 1 in a 380 L kettle with agitation. The kettle was warmed to 60° C. and maintained at that temperature for 4 hours. The resulting mixture was then cooled to room temperature after which it was metered to the top entrance of the wiped film evaporator (WFE) using a Zenith pump (100 cc Zenith BLB, Monroe, N.C.). The WFE rotor speed was 340 RPM. A vacuum of 30 Torr was then applied and the mixture was heated according to the profile shown in Table 2. After 10 minutes, a solvent-free nanosilica particle containing Homide 127A/MX 660 precursor was collected. Thermogravimetric analysis indicated a silica content of 56.7 wt % (72.6 volume percent).

Precursor for Example 2-4: The precursor used for EX 2-4 was prepared using the procedure described for the precursor of EX1 with the following exceptions. The starting materials were used in the amounts given in Table 1, a vacuum of 3333 Pascals (25 torr) was applied, and the feed and temperature conditions were as given in Table 2. Thermogravimetric analysis of EX2-4 indicated silica contents as shown in Table 1. EX5 was prepared as outlined in U.S. Pat. No. 5,648,407 (Goetz et al.). The use of a rotary evaporator enabled the compounding of Os2 into Matrimid 5292A at 66 wt % silica.

TABLE 1

| | | | | | Homide | | MX | Silica |
|---|---|---|---|---|---|---|---|---|
| | Os 1 | Os 2 | Os 3 | MpOH | 127A | Matrimid | 660 | Content |
| EX | (kg) | (kg) | (kg) | (kg) | (kg) | 5292B | (kg) | (wt %) |
| 1 | 141.0 | NA | 26.0 | 26.0 | 10.9 | | 18.2 | 56.7 |
| 2 | 225.1 | NA | 41.8 | 41.8 | 45.5 | | NA | 55.0 |
| 3-4 | NA | 288 | NA | NA | NA | 36.4 | NA | 63.7 |

TABLE 2

| Nanosilica | Sol | Product | | Temperature | | |
|---|---|---|---|---|---|---|
| containing | Mixture | Output | Distillate | Profile (° C) | | |
| precursor to | Feed Rate | Rate | Rate | Zone | Zone | Zone |
| Example | (Kg/hr) | (Kg/hr) | (Kg/hr) | 1 | 2 | 3 |
| 1 | 76.3 | 24.6 | 51.7 | 105 | 150 | 115 |
| 2 | 59.1 | 19.1 | 40.0 | 105 | 150 | 115 |

### Example (EX1-EX5) and Comparative Example (CE1) Preparation

Each of the nanoparticle containing precursors obtained as described above was warmed to 120° C. after which Matrimid 5292A was mixed in using a DAC 600 SpeedMixer (Flacktek, Landrum, S.C.) at 2350 rpm for 45 seconds to provide a well-dispersed resin blend. In a similar manner Matrimid 5292A and Matrimid 5292B were combined to provide a comparative example. For EX1, EX2, EX4, EX5- and CE1, a 1:1 wt ratio of Matrimid 5292A to Matrimid5292B was employed, excluding the amount of silica. CE1 contains no nanosilica for comparative purposes. For EX1, EX2, EX4, and EX5 the final silica content was ca. 40 wt % (37 volume percent). For EX3, a 1:1.3 ratio of Matrimid 5292A to Matrimid5292B was employed, excluding the amount of silica which was 42 wt %. Each resin blend was heated an additional 2 hours with periodic speed mixing.

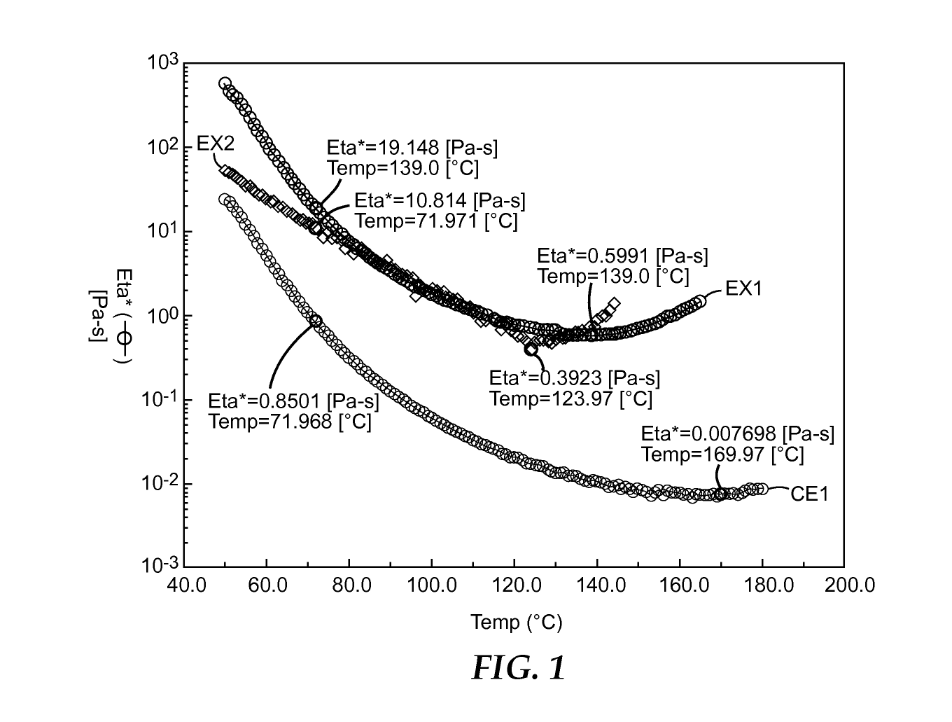

Samples of uncured resins of EX1 and CE1 were evaluated for their viscosity profiles rheologically until the powdered BMI resin dissolves and a thixotropic viscosity profile was obtained as displayed in FIG. 1; cure exotherm; and linear shrinkage as described in the test methods.

### Cured Neat Resin Test Specimen Preparation

Resin samples of EX1-EX45 and CE1 were degassed under vacuum for 3-5 minutes before being poured into appropriate pre-treated with mold-release molds and cured to provide neat resin test specimens. These were used for the evaluation of tensile properties, dynamic mechanical analysis (DMA), thermogravimetric analysis (TGA), hardness, and fracture toughness as described in the test methods. Curing was done in a forced air oven in three stages: 30 minutes at 150° C.; then ramping to 180° C. over 20 minutes and holding for 4 hours at 180° C.; followed by postcuring for 6 hours at 250° C. after a ramp to 250° C. over 20 minutes. Test results are shown in Table 3 and 4.

TABLE 3

| Resin Property | CE1 | EX1 | EX2 | EX3 |
|---|---|---|---|---|
| Wt % nanosilica | 0 | 40 | 40 | 42 |
| Tensile Modulus | 579 | 1058 | 1207 | 1244 |
| (ksi) | | | | |
| Tensile Strength | 11109 | 9902 | 10,244 | 10,119 |
| (psi) | | | | |
| Tensile Strain (%) | 1.40 | 1.20 | 0.91 | 0.87 |
| Fracture Toughness | 0.64 | 0.68 | 0.96 | 1.52 |
| (MPa · √m) | | | | |
| Hardness (Hb) | 55 | 72 | 81 | 82 |
| Linear Shrinkage | 0.66 | 0.35 | 0.36 | 0.29 |
| (%) | | | | |
| Cure Exotherm | 233 | 134 | 139 | 129 |
| (J/g) | | | | |
| Coefficient of | 40 | NA | 24 | NA |
| Thermal Expansion | | | | |
| (mm/m ° C.) | | | | |
| Nanoindentor | | | | |
| Hardness | 0.3 | NA | 4.0 | NA |
| (GPa) | | | | |
| Nanoindentor | 0.6 | NA | 10.0 | NA |
| Modulus | | | | |
| (GPa) | | | | |
| Tg (° C.) | 313 | 313 | 313 | 270 |

TABLE 4

| Resin Property | EX4 | EX5 |
|---|---|---|
| Wt % Silica | 40 | 40 |
| Fracture Toughness | 0.76 | 1.14 |
| (MPa · √m) | | |

FIG. 1 illustrates the increase in viscosity which results from the inclusion of 40 wt % silica. Interestingly, the presence of silica in sample EX1 also affects the onset of resin cure, lowering the cure temperature by ca. 30° C. As previously mentioned the elevation of resin viscosity and the reduction of cure temperature are advantageous improvements. The silica levels incorporated here are higher than those conventionally used.

The effect of ion exchange on neat resin properties can be seen by comparison of EX4 with EX5 displaying a higher value for neat resin fracture toughness as a consequence of ion exchange.

### Carbon Fiber Composite Sample Preparation

Fabric prepreg tape for the nanosilica filled resin systems (EX2, 40 wt % Si) resin system was produced using T300-6K twill carbon fabric. Cytec Cyform 450 tooling prepreg, a commercially available, non-silica containing prepreg on the same fabric was used as a control.

Composite laminates were prepared for the nanosilica BMI (EX6) and the control prepreg (CE2) using typical vacuum bag techniques to achieve porosity-free samples. Laminates were heated from room temperature to 190° C. at 5° C./min using 0.6 MPa of pressure. The laminates were cured at 180° C. for six hours, then were allowed to slowly cool to below 37° C. before removal. The resulting laminates underwent a free standing postcure at 220° C. for 4 hours and then were allowed to slowly cool to below 37° C. before removal.

Two types of laminates were made from each 2×2 twill prepreg. Values for n correspond to and 670 (12 k) gsm fabrics, respectively: a) [0]₄ for compression on 370 (6 k) gsm fabric and b) [0]₄ cut at 45°, for in-plane shear. Nominal cured ply thicknesses for the two prepregs were 0.35, and 0.64 mm, respectively. A wet diamond saw was used to cut specimens. Compression specimen ends were surface-ground to ensure squareness and parallelism.

### Composite Laminate

TABLE 5

| | | Fiber | | Fiber |
|---|---|---|---|---|
| | | Volume | | Volume |
| | | for | | for |
| Property | CE2 | CE2 | EX6 | EX6 |
| Silica (wt %) | 0 | — | 40 | — |
| In-plane Shear Modulus (GPa) | 4.5 | 58 | 5.8 | 63 |
| Compression Strength (GPa) | 0.7 | 61 | 0.7 | 48.1 |
| 0° Flexural Strength (ksi)^{a} | 56.6 | 59 | 64.1 | 55 |
| 0° Flexural Modulus (Msi)^{a} | 0.59 | 59 | 0.70 | 56 |
| Modulus Nanoindentation: | 4.8 | 59 | 15.3 | 61 |
| Resin Region (GPa) | | | | |
| Modulus Nanoindentation: | 14.7 | 59 | 16.8 | 61 |
| Fiber Region (GPa) | | | | |
| Hardness Nanoindentation: | 0.3 | 59 | 0.8 | 61 |
| Resin Region (GPa) | | | | |
| Vickers Hardness: Resin Region | 41 | 59 | 56 | 61 |
| (HV) | | | | |
| Vickers Hardness: Fiber Region | 92 | 59 | 93 | 61 |
| (HV) | | | | |
| z-azis CTE μm/m/° C. | 33 | 59 | 28 | 59 |

Compression strength results for EX6 system and the control CE2 were measured using laminates of significantly different fiber volume fraction. It is notable that even at much lower fiber volume fraction the nanosilica-modified composite had equal strength to the control. If the strength values are normalized to equal fiber volume fraction, the change from the CE2 to the EX6 material is 30%.

Additionally, in-plane shear modulus increased with increased nanosilica content. At 40 wt % nanosilica in EX 6, the increase over the unfilled control CE2 was 29%. However, there is a mismatch in the fiber volume fraction for these panels. If strength values are normalized to equal fiber volume, the change from the control to the EX6 material is 18%.

Enhancements in flexural modulus were found in EX6 versus CE 2 as documented in Table 5. The increased flex modulus may be caused by the increased elastic support given to the fabric which consists of wavy fiber tows. This local stiffness is seen in the nanoindentation modulus. The nanoindentation modulus of the laminate surfaces depends on the proximity of the indentation location to fiber tows near the surface, as seen in Table 4. Because of the well-distributed stiff nanoparticles the nanoindentation modulus is much higher relative to any corresponding area in the unfilled control laminate surface (ie CE2).

As previously mentioned in the resin data section, increasing silica incorporation leads to an increase in surface Barcol hardness for the bulk resin (Table 3). In an effort to determine if the enhanced neat resin hardness transfers into improved composite laminate hardness, Vickers hardness and the determination of hardness by nanoindentation was explored to further confirm the higher hardness of the EX6 system vs the CE2. Resin rich and fiber dominated areas of the laminate were examined and results are summarized in Table 5.

Vickers hardness for the resin-rich regions of the nanosilica-containing EX6 laminate displayed a 38% increase in hardness in comparison to the CE2 control. At these volume fractions, the fiber rich regions showed nearly identical Vickers hardness values. Similar determinations of nanohardness via nanoindentation revealed significant hardness improvements for the EX6 laminate in the resin-rich regions of 300%.

The incorporation of silica also influences dimensional stability of fiber reinforced composite structures, particularly the through-thickness (z-axis) coefficient of thermal expansion (CTE). The z-axis CTE was measured for the EX6 versus the CE2 laminate and average CTE values for these systems are listed in Table 5.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following listing of disclosed embodiments.

1. A curable resin sol comprising an essentially volatile-free, colloidal dispersion of substantially spherical nanosilica particles in a curable bisimide resin, said particles having surface-bonded organic groups which render said particles compatible with said curable bisimide resin.

2. The sol of claim 1 wherein the weight percent the nanosilica particles is equal to or greater than 30 weight percent.

3. The sol of claim 1 wherein the particles are ion exchanged substantially spherical nanosilica particles.

4. The sol of claim 1 wherein the sol has a viscosity greater than the same curable bisimide resin that does not include nanosilica particles.

5. The sol of any of claim 4 wherein the sol has an increase in viscosity of greater than or equal to a 10% increase when compared to the same curable bisimide resin that does not include nanosilica particles.

6. The sol of claim 1 wherein said sol contains less than about 2 weight percent of volatile materials.

7. The sol of claim 1 wherein said nanosilica particles have an average particle diameter in the range of from about 1 nanometer to about 1000 nanometers.

8. The sol of claim 7 wherein said nanosilica particles have an average particle diameter in the range of about 60 nanometers to about 200 nanometers.

9. The sol of claim 1 wherein the curable bisimide resin comprises bismaleimide resin.

10. The sol of any of claim 9 wherein the curable bisimide resin comprises at least one additional curable resin selected from at least one of epoxy resins, imide resins, vinyl ester resins, acrylic resins, bisbenzocyclobutane resins, and polycyanate ester resins.

11. A composition comprising (a) a curable resin sol comprising a colloidal dispersion of substantially spherical nanosilica particles in a curable bisimide resin, said nanosilica particles having surface-bonded organic groups which render said nanosilica particles compatible with said curable bisimide resin; and (b) reinforcing fibers.

12. The composition of claim 11 wherein the weight percent the nanosilica particles is equal to or greater than 30 weight percent of the curable resin sol.

13. The composition of claim 11 wherein the particles are ion exchanged substantially spherical nanosilica particles.

14. The composition of claim 11 wherein the sol has a viscosity greater than the same curable bisimide resin that does not include nanosilica particles.

15. The composition of claim 11 wherein the sol has an increase in viscosity greater than or equal to a 10% increase when compared to the same bisimide resin that does not include nanosilica particles.

16. The composition of claim 11 wherein said composition contains less than about 2 weight percent of volatile materials.

17. The composition of claim 11 wherein said nanosilica particles have an average particle diameter in the range of from about 1 nanometer to about 1000 nanometers.

18. The composition of claim 17 wherein said nanosilica particles have an average particle diameter in the range of about 60 nanometers to about 200 nanometers.

19. The composition of claim 11 wherein the curable bisimide resin comprises bismaleimide resin.

20. The composition of claim 11 wherein the curable bisimide resin comprises at least one additional curable resin selected from at least one of epoxy resins, mide resins, vinyl ester resins, acrylic resins, bisbenzocyclobutane resins, and polycyanate ester resins.

21. The composition of claim 11 wherein said surface-bonded organic groups organosilanes.

22. The composition of claim 11 wherein said reinforcing fibers are continuous.

23. The composition of claims 11 wherein said reinforcing fibers comprise carbon, glass, ceramic, boron, silicon carbide, polyimide, polyamide, polyethylene, or combinations thereof.

24. The composition of claim 11 wherein said reinforcing fibers comprise a unidirectional array of individual continuous fibers, woven fabric, knitted fabric, yarn, roving, braided constructions, or non-woven mat.

25. The composition of claim 23 wherein the curable bisimide resin content is less than or equal to 32 volume percent based on the total weight of the composition when the reinforcing fibers comprise 61 volume percent.

26. The composition of claim 23 wherein the curable bisimide resin content is less than or equal to 41 volume percent based on the total weight of the composition when the reinforcing fibers comprise 50 volume percent.

27. The composition of claim 11 further comprising at least one additive selected from the group consisting of curing agents, cure accelerators, catalysts, crosslinking agents, dyes, flame retardants, pigments, impact modifiers, and flow control agents.

28. A prepreg comprising the composition of claim 11.

29. A composite comprising the cured composition of claim 11.

30. The composite of claim 29 wherein the nanosilica particles are uniformly distributed throughout the cured composition.

31. A thick article comprising: a cured composition comprising (a) a curable resin sol comprising a colloidal dispersion of substantially spherical nanosilica particles in a curable bisimide resin, said nanosilica particles having surface-bonded organic groups which render said nanosilica particles compatible with said curable bisimide resin; and (b) reinforcing fibers, wherein the thick article comprises at least 30 weight percent of nanosilica particles based on the total weight of the curable resin sol.

32. The thick article of claim 31 wherein the nanosilica particles are uniformly distributed throughout the cured composition.

33. A process for preparing fiber-containing compositions comprising the steps of (a) forming a mixture comprising a curable bisimide resin and at least one organosol, said organosol comprising volatile liquid and substantially spherical nanosilica particles, said nanosilica particles having surface-bonded organic groups which render said nanosilica particles compatible with said curable resin;
(b) removing said volatile liquid from said mixture so as to form a curable resin sol; and (c) combining said mixture or said curable resin sol with reinforcing fibers so as to form an essentially volatile-free fiber-containing composition.

34. The process of claim 33 further comprising the step of curing said fiber-containing composition.

35. The process of claim 33 wherein said combining is carried out according to a process selected from the group consisting of resin transfer molding, pultrusion, and filament winding.

36. A prepreg prepared by the process of claim 33.

37. A composite prepared by the process of claim 33.

38. An article comprising the composite of claim 37.
